(19) United States
(12) Patent Application Publication
(10) Pub. No.: US 2011/0161059 A1
(43) Pub. Date: Jun. 30, 2011

(54) Method for Constructing a Gray-Box Model of a System Using Subspace System Identification

(76) Inventors: Ankur Jain, Dublin, CA (US); Daniel Nikovski, Brookline, MA (US)

(21) Appl. No.: 12/650,441

(22) Filed: Dec. 30, 2009

(51) Int. Cl. G06G 7/56; G06F 17/10

(52) U.S. Cl. 703/2; 703/9

(57) ABSTRACT

A gray-box model of a system is constructed by specifying constraints for the system and applying subspace system identification to inputs and outputs of the system to determine system matrices and system state sequences for the system. A transformation matrix that satisfy the constraints from the system matrices and the system state sequences is determined, wherein the transformation matrix defines parameters of the gray-box model.

### FIELD OF THE INVENTION

This invention relates generally to modeling systems, and more particularly to modeling heat transfer in buildings using gray-box models and subspace box system identification.

### BACKGROUND OF THE INVENTION

### System Models

A dynamical system model describes an operation of a system in either the time or frequency domain. The system of particular interest to the invention is a building, with occupants and environmental control subsystems. It is desired to model and predict heat transfer in buildings.

White-Box Models

A white-box model is based on fundamental known physical characteristics of the system. If the system is a building, then the white-box model requires detailed information about the building, such as thermal dynamics, geometry, thermal transfer coefficients, environmental control subsystems, and occupancy patterns. Such information is not always available, especially for old buildings. White-box model tends to be overly complex, and possibly even impossible to obtain in reasonable time due to the complex nature of many systems.

System Identification

An alternative approach is to learn a model from the measurements of inputs and outputs of the system. The model determines the relationship between the inputs and output without an exact understanding of the internal operation of the system as required by the white-box models. In the art and literature, this is well known and generally termed “system identification,” see U.S. Pat. No. 4,362,269.

Black-Box and Gray-Box Models

Black-box models are based strictly on the relationship between input and output data, without knowing the internal workings of the system. However, the resulting model parameters have no physical meaning, and the model is difficult to understand.

Gray-box models are based on intermediate variables of the system, such as physically meaningful parameters, so that a state-space model correctly models the data. However, the models operate as black-boxes during modeling. Manipulating the input data and output do not qualify as gray box, because the input and output are clearly outside of the “black-box.”

Black-Box

In a linear time invariant black-box model, the relationship between the input and output signals is represented as a first-order differential equation using a state vector (sequence) x(k). The input signal sampled a regular time intervals at time k is u(k) and the output signal is y(k). The black-box system is modeled as:

x(k+1)=Ax(k)+Bu(k), and

y(k+1)=Cx(k)+Du(k). (1)

Given the input data u(k), and the corresponding output data y(k), the system identification determines the system matrices A, B, C and D.

Gray-Box

Correspondingly, given a vector θ of physically meaningful parameters, the gray-box linear time-invariant system (LTI) system is

x(k+1)=A(θ)x(k)+B(θ)u(k),

y(k)=C(θ)x(k)+D(θ)u(k). (2)

Given an invertible transformation matrix Φ, such that \tilde{x}(k)=Φ⁻¹x(k), the black-box model of Equation 1 can also be represented as

\tilde{x}(k+1)=Φ⁻¹AΦ\tilde{x}(k)+Φ⁻¹Bu(k),

y(k)=CΦ\tilde{x}(k)+Du(k). (3)

The gray-box system identification task determines the parameter vector (θ). Typically, the parameter vector of the gray-box model is obtained using iterative optimization techniques, such as a prediction error method (PEM), or a maximal likelihood (ML) technique.

U.S. Patent Publication 2004/0181498 describes a method for constructing a gray-box model. That method also requires a goodness-of-fit criteria during a constrained optimization to evaluate a performance of that gray-box model.

### SUMMARY OF THE INVENTION

The embodiments of the invention provide a method for constructing a gray-box model of a system using subspace system identification, which is a form of system identification. In an example application, the system is a building, and thermal transfer in a building is modeled. However, it is understood that the method can be used generally to construct gray-box models for arbitrary systems.

The method combines resistance-capacitance (RC) networks and gray-box models with black-box system identification.

The method has significant reduction in complexity without compromising performance. In addition, the method significantly reduces the dependence of the system identification task on iterative procedures.

### BRIEF DESCRIPTION OF THE DRAWINGS

FIG. 1 is a schematic of a system modeled according to embodiments of the invention;

FIG. 2 is a schematic of a resistance-capacitance (RC) network constraining the system of FIG. 1 according to embodiments of the invention;

FIG. 3 is a flow diagram of a method for constructing a gray-box model for the system of FIG. 1 using the constraints of the network of FIG. 2.

### DETAILED DESCRIPTION OF THE PREFERRED EMBODIMENTS

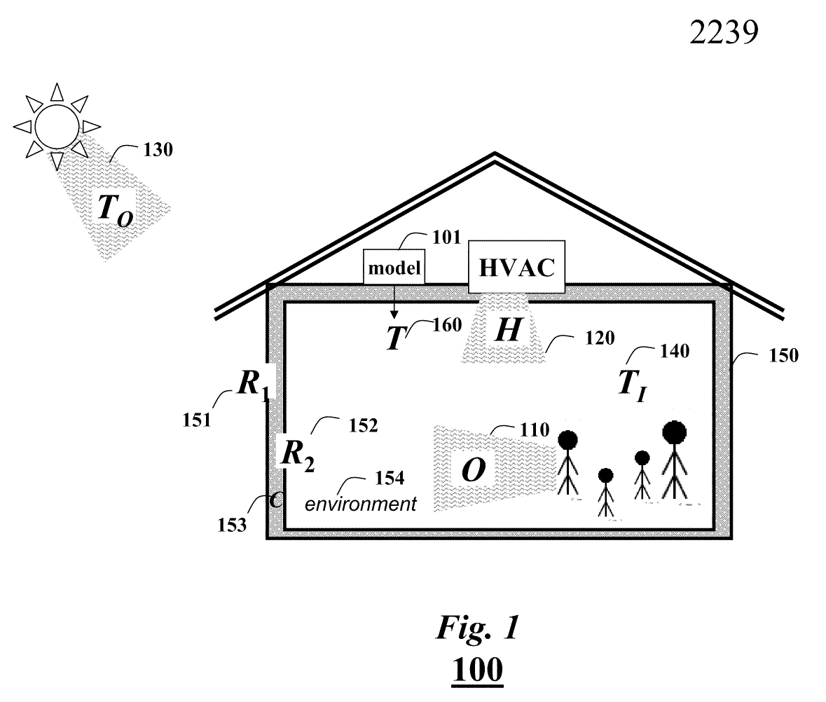

FIG. 1 shows a system 100 to be modeled according to embodiments of our invention. In an example application, the system is a building. We desired to model 101 heat transfer in the building.

The sources of heat for the inside of the building include the environment 154 (appliances, equipment, etc), occupant heat (O) 110, heating, ventilation and air conditioning (HVAC) (H) 120, solar radiation and outside environment heat (T_{O}) 130. Occupancy statistics (location, density, and time) can also be provided. The temperature inside the building is T_{I} 140.

System Constraints

A resistance R₁ 151 models thermal transfer between an outside surface of a wall 150 and the outside environment, and a resistance R₂ 152 models the transfer between the inside surface of the wall and inside environment. The capacitance C 153 corresponds to the thermal mass of the wall.

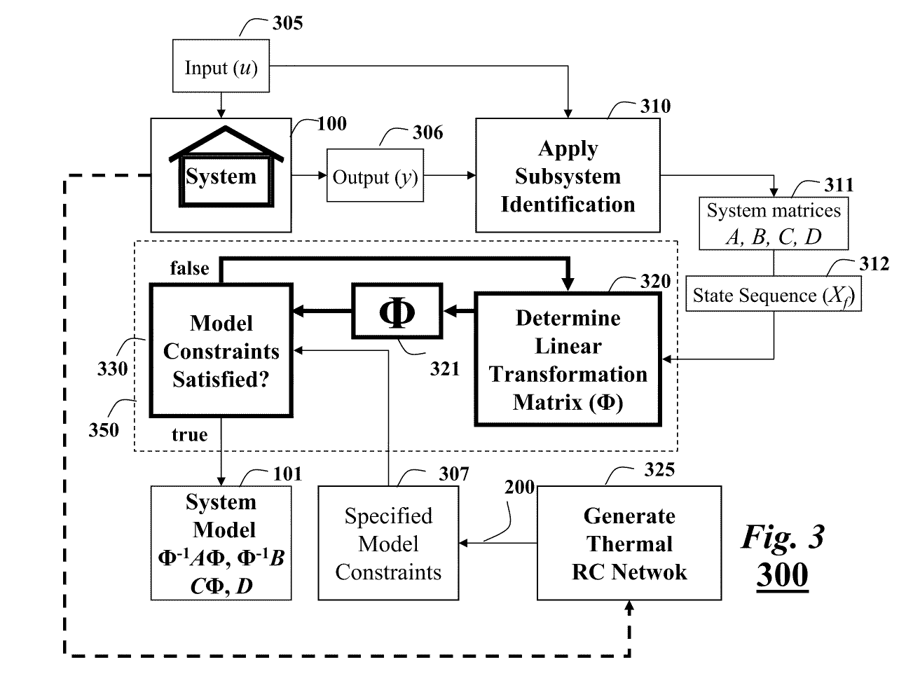

As shown in FIG. 3, the embodiments of the invention provide a method 300 for constructing the thermal model 101 for the building 100 using gray-box models and subspace system identification.

During operation of the system 100, the model 101 is provided with inputs to the system, while outputs, e.g., the temperature, are predicted in real-time. The predicted outputs can be used to optimally control the environment inside the building.

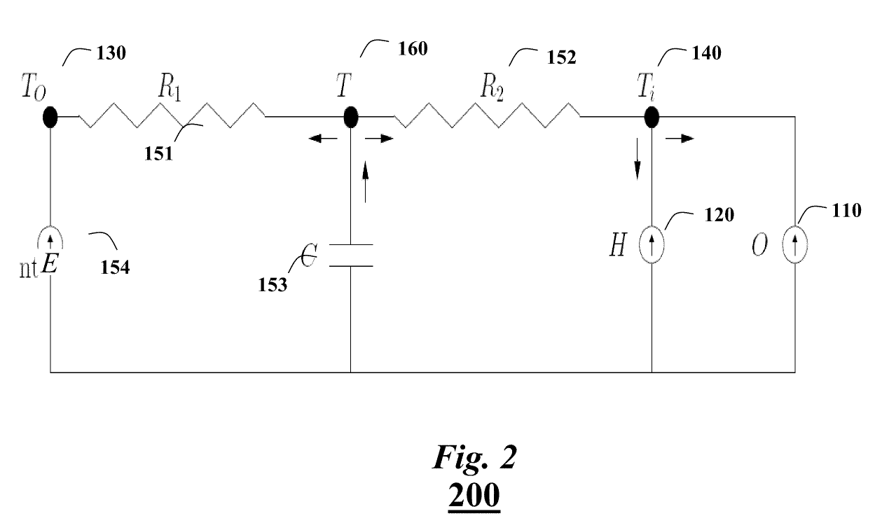

FIG. 2 shows a resistance-capacitance (RC) network 200 generate for the thermal transfer in the building. The RC network specifies constraints for the gray-box model based on physically meaningful parameter as described for Equation 4 below.

The occupants and the HVAC act as current (heat) as sources O 110 and H 120, respectively, as well as the environment (E) 154. The parameters of the model are R₁, R₂ and C. The temperatures T_{O}, H and O are inputs, T 160 is an output, where T is a state of the thermal network, for example a desired temperature. The current (heat) flows in the direction of the arrow.

Model Construction Method

The method for constructing the gray-box model 101 for the system 100 is shown in FIG. 3. The method can be performed in a processor including a memory and input/output interfaces as known in the art.

The system 100 has u 305 as input and y 306 as output. In the context of the building, the input includes the outside temperature, the building occupancy pattern, heat delivered by the HVAC system etc., and the output is the predicted or desired temperature T 160 inside the building.

The method 300 generates 325 the RC network 200 for the system 100 to specify constraints 307 that are physically meaningful for the gray-box model 101 of the system 100.

Subspace box system identification 110 is applied to the input and output to determine system matrices A, B, C and D 111 and state sequences X_{f} 112, which cannot be measured directly from the system. System identification, as described above, concerns the construction of models of dynamical systems from input and output data. Subspace system identification is a class of methods for estimating state space models based on low rank observed properties of systems. Subspace system identification is now an established methodology for system modeling. The basic theory of subspace system identification is well understood, and used as a standard tool in industry, see U.S. Pat. No. 6,864,897 for example. Subspace system identification has never been used for constructing Gray-box models.

Iterative optimization 350 is used to determine 120 an appropriate linear transformation matrix Φ 121, such that A(θ)=Φ⁻¹ AΦ, B(θ)=Φ⁻¹ B, C(θ)=CΦ and D=D. Initially, the matrix Φ is based on the system matrices 111 and the state sequences 112. The matrix Φ is optimally modified for each iteration 350 until the specified constraints 307 are satisfied.

Satisfaction of the model constraints 307 for the current matrix Φ is determined 330. If false, a new transformation matrix Φ is determined 320 for the next iteration. Otherwise, if true, the system model 101 is output, and can be used to operate environmental control subsystems of the building.

Current Balance

The constraint for a current balance for the RC network 200 is

$$\frac{δ T}{δ t} = [ \frac{1}{{R}_{1} C} + \frac{1}{{R}_{2} C} ] [ T ] + {[ \begin{matrix}\frac{- 1}{{R}_{1} C} & \frac{- 1}{{R}_{2} C} & 0 & 0\end{matrix} ] [ \begin{matrix}{T}_{O} & {T}_{i} & H & O\end{matrix} ]}^{T} \\ {T}_{i} = \begin{matrix}[ 1 ] & [ T ]\end{matrix} + {[ \begin{matrix}0 & 0 & - {R}_{2} & - {R}_{2}\end{matrix} ] [ \begin{matrix}{T}_{O} & {T}_{i} & H & O\end{matrix} ]}^{T} , \\ where \\ x = T , u = {[ \begin{matrix}{T}_{O} & {T}_{i} & H & O\end{matrix} ]}^{T} , y = {T}_{i} , θ = [ \begin{matrix}{R}_{1} & {R}_{2} & C\end{matrix} ] . \qquad ( 4 )$$

An equivalent representation according to Equation 2 in the state space is

$$A ( θ ) = [ \frac{1}{{R}_{1} C} + \frac{1}{{R}_{2} C} ] , B ( θ ) = [ \begin{matrix}\frac{- 1}{{R}_{1} C} & \frac{- 1}{{R}_{2} C} & 0 & 0\end{matrix} ] , \\ where C ( θ ) = [ 1 ] and D ( θ ) = [ \begin{matrix}0 & 0 & - {R}_{2} & - {R}_{2}\end{matrix} ] . \qquad ( 5 )$$

The gray-box model of Equation 5 specifies the constrains such as C=[1], the last two elements of the matrix D are zero, the last two elements of the matrix D are the same, and the first two elements of the matrix D are zero, and the like.

Different buildings with different geometries and input and output data have different thermal RC networks, and thus, different constraints 307.

Given an input-output sequence of data such that u=(u(0), u(1), . . . , u(N+2k−2)), and y=(y(0), y(1), . . . y(N+2k−2)), Hankel matrices Uₚ, U_{f}, Yₚ, Yf are

$${U}_{p} = {U}_{0 \vert k - 1} = [ \begin{matrix}u ( 0 ) & u ( 1 ) & … & u ( N - 1 ) \\ u ( 1 ) & u ( 2 ) & … & u ( N ) \\ ⋮ & ⋮ & ⋮ & ⋮ \\ u ( k - 1 ) & u ( k ) & … & u ( N + k - 2 )\end{matrix} ] . \\ {Y}_{p} = {Y}_{0 \vert k - 1} = [ \begin{matrix}y ( 0 ) & y ( 1 ) & … & y ( N - 1 ) \\ y ( 1 ) & y ( 2 ) & … & y ( N ) \\ ⋮ & ⋮ & ⋮ & ⋮ \\ y ( k - 1 ) & y ( k ) & … & y ( N + k - 2 )\end{matrix} ] . \\ {U}_{f} = {U}_{k \vert 2 k - 1} = [ \begin{matrix}u ( k ) & u ( k + 1 ) & … & u ( N + k - 1 ) \\ u ( k + 1 ) & u ( k + 2 ) & … & u ( N + k ) \\ ⋮ & ⋮ & ⋮ & ⋮ \\ u ( 2 k - 1 ) & u ( 2 k ) & … & u ( N + 2 k - 2 )\end{matrix} ] . \\ {Y}_{f} = {Y}_{k \vert 2 k - 1} = [ \begin{matrix}y ( k ) & y ( k + 1 ) & … & y ( N + k - 1 ) \\ y ( k + 1 ) & y ( k + 2 ) & … & y ( N + k ) \\ ⋮ & ⋮ & ⋮ & ⋮ \\ y ( 2 k - 1 ) & y ( 2 k ) & … & y ( N + 2 k - 2 )\end{matrix} ] . \qquad ( 6 )$$

Given the LTI system according to Equation 1, the observability matrix Oₖ and the Toeplitz matrix ψₖ are respectively

$${O}_{k} = [ \begin{matrix}C \\ CA \\ ⋮ \\ {A}^{k - 1}\end{matrix} ] , {Ψ}_{k} = [ \begin{matrix}D & & & \\ CB & D & & \\ ⋮ & ⋱ & ⋱ & \\ {CA}^{k - 1} B & … & CB & D\end{matrix} ] . \qquad ( 7 )$$

Using the state transition relation in Equation 1, the state sequence X_{f} of the LTI system, given the input sequence U_{f} and measurements Y_{f} are

Y_{f}=OₖX_{f}+ΨₖU_{f}. (8)

In system identification, if

$${W}_{p} = [ \begin{matrix}{U}_{p} \\ {Y}_{p}\end{matrix} ] ,$$

then a QR factorization technique

$$[ \begin{matrix}{U}_{f} \\ {W}_{p} \\ {Y}_{f}\end{matrix} ] = [ \begin{matrix}{R}_{11} & 0 & 0 \\ {R}_{21} & {R}_{22} & 0 \\ {R}_{31} & {R}_{32} & 0\end{matrix} ] [ \begin{matrix}{Q}_{1}^{T} \\ {Q}_{2}^{T} \\ {Q}_{3}^{T}\end{matrix} ] , \qquad ( 9 )$$

which reduced to,

Y_{f}=(R₃₁−R₃₂R₂₂^{†}R₂₁)R₁₁⁻¹U_{f}+R₃₂R₂₂^{†}Wₚ (10)

where † represents the pseudo-inverse of a matrix. Then, using Equation 8 and Equation 10,

OₖX_{f}=R₃₂R₂₂^{†}Wₚ. (11)

Using a singular value decomposition (SVD) and the arbitrary invertible matrix Φ, see Equation 3, Equation 11 reduces to

$$\begin{matrix}\begin{matrix}{O}_{k} {X}_{f} = {R}_{32} {R}_{22}^{†} {W}_{p} , \\ = U Σ {V}^{T} , \\ = ( U {Σ}^{1 / 2} Φ ) ( {Φ}^{- 1} {Σ}^{1 / 2} {V}^{T} ) .\end{matrix} & ( 12 ) \\ {X}_{f} = {Φ}^{- 1} {Σ}^{1 / 2} {V}^{T} . & ( 13 )\end{matrix}$$

Thus, for a given user parameter k, see Equation 6, there can be many different realizations of the state sequences arising from the same LTI system based on different values of the matrix Φ.

The method 300 determines X_{f} using non-iterative procedures of subspace system identification procedures, and aims to find the appropriate matrix Φ based on the constraints 307 from the gray-box model using iterative optimization 350.

For example, for if the system design engineer modeling a thermo-dynamical system knows from the physical constraints on the system that the system is third-order, such that the rate of change of all the states is the same, then the matrix A in Equation (3) a 3×3 matrix, such that all its rows are the same. Therefore, the constraints 307 are satisfied to determine the appropriate matrix Φ for the system.

Using the state sequence 312, the following data sequences are obtained:

$$\begin{matrix}{X}_{k + 1} = [ x ( k + 1 ) … x ( k + N - 1 ) ] . & ( 14 ) \\ {X}_{k} = [ x ( k ) … x ( k + N - 2 ) ] . & ( 15 ) \\ {U}_{k} = [ x ( k ) … x ( k + N - 2 ) ] . & ( 16 ) \\ {Y}_{k} = [ y ( k ) … x ( k + N - 2 ) ] . & ( 17 )\end{matrix}$$

If Equation 1 is represented in matrix notation as

$$[ \begin{matrix}{X}_{k + 1} \\ {Y}_{k}\end{matrix} ] = [ \begin{matrix}A & B \\ C & D\end{matrix} ] [ \begin{matrix}{X}_{k} \\ {U}_{k}\end{matrix} ] , \qquad ( 18 )$$

then the system matrices 311 can be determined found using linear regression as

$$[ \begin{matrix}A & B \\ C & D\end{matrix} ] = ( {[ \begin{matrix}{X}_{k + 1} \\ {Y}_{k}\end{matrix} ] [ \begin{matrix}{X}_{k} \\ {U}_{k}\end{matrix} ]}^{T} ) {( {[ \begin{matrix}{X}_{k} \\ {U}_{k}\end{matrix} ] [ \begin{matrix}{X}_{k} \\ {U}_{k}\end{matrix} ]}^{T} )}^{- 1} . \qquad ( 19 )$$

Equation 19 gives a minimalistic realization Ξ of the system, which is modified using the linear transformation matrix Φ within the constraints 307 of the gray-box model 101.

A realization of the system under the influence of a transformation matrix is represented as Ξ(Φ). Therefore, the system realized in Equation 19 is given by Ξ(I), where I is an identity matrix. Using Equation 3,

$$Ξ ( Φ ) = [ \begin{matrix}{Φ}^{- 1} A Φ & {Φ}^{- 1} B \\ C Φ & D\end{matrix} ] . \qquad ( 20 )$$

A new realization Ξ(Φ) can be obtained by simply formulating a modified matrix Φ without any redetermining the matrices A, B, C and D. The matrix D is invariant to the matrix Φ.

Conventionally, the element of a matrix are referenced using subscripted indices, For example, the element at i^{th} row and the j^{th} column of the matrix A is aᵢⱼ.

The constraints from the gray-box models are on these individual elements of the system matrices and can be used to determine the appropriate transformation matrix Φ using a conventional constrained optimization procedure, such as the fmincon function in MATLAB, which attempts to find a constrained minimum of a scalar function of several variables starting at an initial estimate. This is generally referred to as constrained nonlinear optimization or nonlinear programming. The function fmincon uses a Hessian, which is the second derivative of a Lagrangian.

The constraints from a particular gray-box model are Con, the size and nature of which depend on the properties of the gray-box model. For example, consider a 2^{nd} order gray-box model with the following system matrices:

$$A = [ \begin{matrix}{a}_{11} & 0 \\ 1 & {a}_{11}\end{matrix} ] , B = [ \begin{matrix}{b}_{11} & {b}_{12} \\ {b}_{21} & {a}_{11}\end{matrix} ] , and \\ C = [ \begin{matrix}{c}_{11} & {c}_{12}\end{matrix} ] , D = [ \begin{matrix}{d}_{11} & {d}_{12}\end{matrix} ] . \qquad ( 21 )$$

If the system obtained using Equations 6-20 is denoted by Ξ(Φ), where Ξᵢⱼ(Φ) denotes the element at the i^{th} row and the j^{th} column of the matrix, the constraints Con for the problem are

$$Con = \{ \begin{matrix}{Ξ}_{11} ( Φ ) - {Ξ}_{22} ( Φ ) = 0 \\ {Ξ}_{12} ( Φ ) = 0 \\ {Ξ}_{21} ( Φ ) - 1 = 0 \\ {Ξ}_{24} ( Φ ) - {Ξ}_{22} ( Φ ) = 0.\end{matrix} \qquad ( 22 )$$

One method to determine the transformation matrix Φ satisfying the constraints in Equation 22 is to optimize

$$\hat{Φ} = arg {min}_{Φ} ( \begin{matrix}{\vert {Ξ}_{11} ( Φ ) - {Ξ}_{22} ( Φ ) \vert}^{2} + {\vert {Ξ}_{12} ( Φ ) \vert}^{2} + \\ {\vert {Ξ}_{21} ( Φ ) - 1 \vert}^{2} + {\vert {Ξ}_{24} ( Φ ) - {Ξ}_{22} ( Φ ) \vert}^{2}\end{matrix} ) . \qquad ( 23 )$$

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for constructing a gray-box model of a system, comprising:
specifying constraints for the system;
applying subspace system identification to inputs and outputs of the system to determine system matrices and system state sequences for the system; and
determining a transformation matrix that satisfy the constraints from the system matrices and the system state sequences, wherein the transformation matrix defines parameters of the gray-box model, wherein the specifying, applying and determining are performed in a processor.

2. The method of claim 1, wherein the system is a building, and the gray-box model models heat transfer in the building.

3. The method of claim 2, further comprising:
predicting temperatures in the building using the gray-box model.

4. The method of claim 1, wherein the determining comprises an iterative optimization.
